(19) United States
(12) Patent Application Publication
(10) Pub. No.: US 2026/0319782 A1
(43) Pub. Date: Oct. 15, 2026

(54) DETECTING UPDATES TO LOWER-LEVEL DEPENDENCIES FOR A SOFTWARE PROGRAM

(71) Applicant: Red Hat, Inc., Raleigh, NC (US)

(72) Inventor: Stephen Kenneth Kitt, Puteaux (FR)

(73) Assignee: Red Hat, Inc., Raleigh, NC (US)

(21) Appl. No.: 19/179,927

(22) Filed: Apr. 15, 2025

(51) Int. Cl. G06F 8/65; G06F 8/41

(52) U.S. Cl. CPC G06F 8/65; G06F 8/433

(57) ABSTRACT

In one example, a system can receive a dependency tree associated with a first software program. The dependency tree can indicate that the first software program has a first dependency on a second software program and a second dependency on a third software program. The dependency tree can further indicate that the third software program has a third dependency on the second software program. The system can determine an update to the third dependency for the third software program. The update can be from relying on the second software program to relying on a fourth software program. The system can cause an action associated with the first software program based on determining the update.

### TECHNICAL FIELD

The present disclosure relates generally to software execution. More specifically, but not by way of limitation, this disclosure relates to detecting updates to lower-level dependencies for a software program.

### BACKGROUND

Software code for a software program can be executed by a processor to perform various operations. The software program can invoke dependency programs on which the software program may depend. The dependency programs can further invoke additional dependency programs. Software developers may release updates for their software when a defect (e.g., vulnerability) is discovered. For example, software developers may release a patch, or an entirely new version of the software. So, updates may be made to the software program or any of the dependency programs.

### BRIEF DESCRIPTION OF THE DRAWINGS

FIG. 1 shows a block diagram of an example of a system for detecting updates to lower-level dependencies for a software program according to some aspects of the present disclosure.

FIG. 2 shows an example of a lower-level dependency update being applied to a software program according to some aspects of the present disclosure.

FIG. 3 shows a block diagram of an example of a computer system for detecting updates to lower-level dependencies for a software program according to some aspects of the present disclosure.

FIG. 4 shows a flowchart of an example of a process for detecting updates to lower-level dependencies for a software program according to some aspects of the present disclosure.

### DETAILED DESCRIPTION

Software developers may update software programs to correct defects such as vulnerabilities or to add or remove certain functionality. These updates may be entire version upgrades or dependency replacements. A software program can have dependencies on other software programs to implement some functionality of the software program. In addition, the other software programs that the software program is dependent on can also be dependent on additional software programs. As such, a software program has various levels of dependencies, where its direct dependencies can be considered first-level dependencies, and dependencies of the first-level dependencies can be considered lower-level dependencies. In addition, software programs may be reused as dependencies across a variety of software programs, so some software programs may become unmaintained, or a newer and better version may become available. But, detecting updates to dependencies across a large ecosystem of software programs may be difficult. Most software programs end up with complex dependency trees showing the other software programs they depend upon to provide their full feature set. Conventional dependency tracking tools may miss complex upgrades involving transitions to different dependencies, for example the availability of a new, backwards-incompatible version of a dependency in ecosystems where that results in a different dependency name or a migration from an unmaintained dependency to a maintained replacement. In addition, the changeover from one dependency to another may be time and resource intensive since each separate software program typically has to separately find out there is a new dependency available unless a developer manually informs all of the software programs.

Some examples of the present disclosure can overcome one or more of the abovementioned problems by automatically updating a software program in a computing environment based on detecting lower-level dependency changes. For example, a computing environment can monitor a software program and its dependencies, as well as other software programs and their dependencies. Examples of such dependencies include libraries, packages, etc. By monitoring the software program, the computing environment can identify when a lower-level dependency of the software program is updated. The computing environment can then determine whether the update is suitable for the software program itself (e.g., if the software program has a direct dependency on the same software program as the lower-level dependency). If so, the computing environment can cause a notification about the update to be output such that a developer can then implement the update for the software program. Or, the computing environment can automatically implement the update for the software program. As such, dependency management may be centralized and relevant updates may be efficiently detected and implemented across the system, reducing time and computing resources used in dependency updates.

To illustrate, a system can receive a dependency tree that indicates that a main software program depends on software program A and software program B as direct, or first-level, dependencies. In addition, the dependency tree can indicate that software program B depends on software program A and software program C as indirect, or lower-level dependencies. At some point and independent of the main software program, the software program B can upgrade to software program A2, replacing its dependency on software program A. So, the main software program can still depend on software program A, but software program B can now depend on software program A2 and software program C. The system can analyze the change and determine an action to perform based on the change. For example, the system can generate a notification of the update from software program A to software program A2 such that a developer of the main software program can determine whether the main project is to be updated from depending on software program A to software program A2. The system may also automatically update the main software project to depend on software program A2. As such, a change to a lower-level dependency that is relevant to the main software program is efficiently detected and implemented, which can result in better performance of the main software program and the dependencies.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

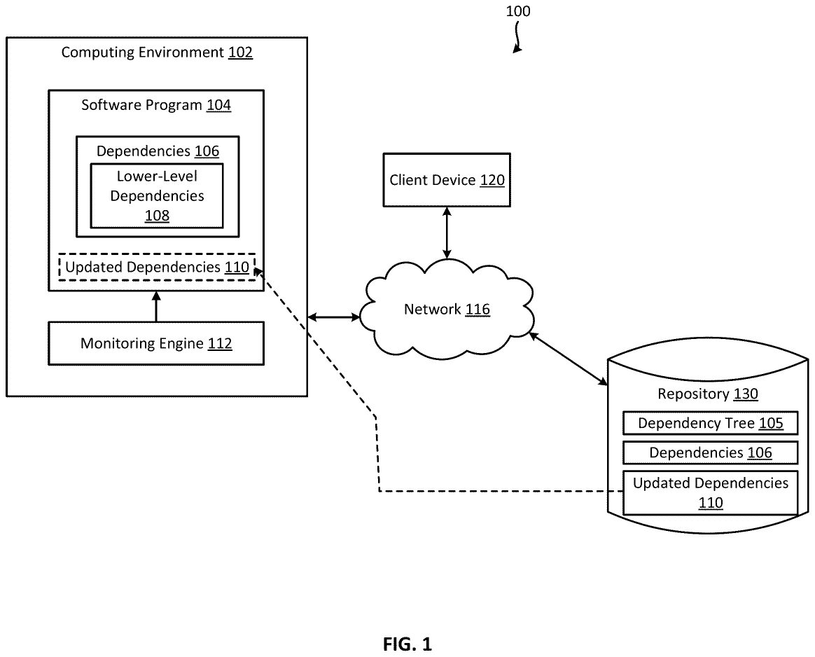

FIG. 1 shows a block diagram of an example of a system 100 for detecting updates to lower-level dependencies for a software program 104 according to some aspects of the present disclosure. Examples of the software program 104 may include an application, a microservice, a serverless function, etc. The software program 104 can be deployed in a computing environment 102. In some examples, the computing environment 102 may be a distributed computing environment, such as a cloud computing environment, a computing cluster, or a data grid. Such distributed computing environments may include multiple networked nodes (e.g., physical or virtual machines) that cooperate with one another to perform various tasks.

As the software program 104 executes in the computing environment 102, it may invoke one or more dependencies 106 (e.g., other software programs). Examples of such dependencies 106 can include other software programs, such as packages, libraries, etc. The dependencies 106 may be developed by the same entity that developed the software program 104 and/or by other parties. For instance, one or more of the dependencies 106 may be created and maintained by other developers, who may post their projects for the public to download on GitHub® or other websites. To save time, a software developer may download those dependencies 106 and incorporate them into the software program 104 to perform functions, rather than directly programming the dependencies 106. The dependencies 106 may be downloaded from a repository 130, which can include any number of websites, repositories, and/or other sources of dependencies.

In some examples, the dependencies 106 of the software program 104 may have their own dependencies, which can be referred to as lower-level dependencies 108. So, during an execution of the software program 104, the software program 104 may invoke a first dependency (e.g., a first-level dependency), which then can invoke a second dependency (e.g., a second-level dependency). The second dependency can correspond to a lower-level dependency. In addition, the second dependency can further invoke other dependencies, and so on. As such, the lower-level dependencies 108 can refer to any dependency invoked by a dependency of the software program 104 in the execution of the software program 104.

In some examples, the computing environment 102 can execute a monitoring engine 112 to determine the dependencies 106 invoked by the software program 104. The monitoring engine 112 may be a centralized service that monitors dependencies across software programs. Or, the monitoring engine 112 may monitor the dependencies for a single software program (e.g., the dependencies 106 for the software program 104). In such examples, the monitoring engine 112 may include application programming interfaces (APIs) that look for changes to the dependencies 106. To determine the dependencies 106, the monitoring engine 112 may implement one or more techniques. For example, the monitoring engine 112 may receive a dependency tree 105 associated with the software program 104. The dependency tree 105 can indicate the dependencies 106 of the software program 104 as well as the lower-level dependencies 108 of the dependencies 106. Each software program can have a file that describes its dependencies. So, the dependency tree 105 can be determined and generated based on the file for each software program associated with executing the software program 104.

In some examples, the dependency tree 105 may indicate that the software program 104 has a first dependency on a second software program and a second dependency on the third dependency on a third software program. The second software program and the third software program are thus the dependencies 106 for the software program 104. In addition, the dependency tree 105 can indicate that third software program has a third dependency on the second software program. So, the third dependency on the second software program can be a lower-level dependency of the lower-level dependencies 108 for the software program 104.

Updating dependencies appropriately at all levels for the software program 104 may be difficult due to the complexity of the dependency tree 105 for software program 104 and dependency trees for other software programs in the system 100. To address the issue with updating dependencies, the monitoring engine 112 can determine when a change occurs to a lower-level dependency used by a dependency of the software program 104. The monitoring engine 112 can determine whether the software program 104 itself depends on the lower-level dependency. If so, the monitoring engine 112 can determine whether the update to the lower-level dependency is appropriate for the software program 104. If the update is suitable for the software program 104, then the computing environment 102 can update the dependencies 106 to generate updated dependencies 110 that include the update.

As a particular example, the monitoring engine 112 may determine that the third software program, which has the third dependency on the second software program, is updated to rely on a fourth software program rather than the second software program. The fourth software program may be a new software program or a major version update (e.g., from v1.1 to v2.0) of the second software program. The monitoring engine 112 may identify the update in a dependency tree for the third software program, where the dependency on the second software program is replaced with a dependency on the fourth software program.

The monitoring engine 112 can additionally or alternatively determine the update by accessing the repository 130 and determining a change to the file describing the dependencies of the third software program. The change to the file can indicate the update. The monitoring engine 112 may determine the update to the lower-level dependency during an update to the third software program since the file can be changed during the update to the third software program. In response to determining the change to the file, the monitoring engine 112 can determine an indication of a type of the change in another file associated with the third software program. For example, the other file may be a change control document that indicates the change from the second software program to the fourth software program. Upon determining that the change corresponds to a replacement of the second software program with the fourth software program, which is a different software program than the second software program, the monitoring engine 112 can determine that a similar update of the first dependency on the second software program for the software program 104 to the fourth software program is to be applied.

So, in general, for each first-level dependency being upgraded, the monitoring engine 112 can determine the lower-level dependencies 108 of the first-level dependency. After the upgrade for the first-level dependency, the monitoring engine 112 can determine lower-level dependency changes for the first-level dependency. The monitoring engine 112 can then look up the corresponding change in the change control of the first-level dependency. If the monitoring engine 112 determines that a change is a lower-level dependency being replaced by another, the monitoring engine 112 can determine that the change may be suitable for the first-level dependency as well.

After identifying the update to a lower-level dependency for the software program 104, the computing environment 102 can cause an action associated with the software program 104 to be performed. As an example, the computing environment 102 may determine that based on the update, the dependencies 106 for the software program 104 are to be updated such that the software program 104 relies on the software program that was updated in the lower-level dependencies 108 (e.g., the fourth software program). So, the computing environment 102 can cause the first dependency of the software program 104 to be updated such that the software program 104 relies on the fourth software program rather than the second software program in the updated dependencies 110.

To make the update to the dependency for the software program 104, a change to the name of the dependency can be made in the dependency file, where the changed name corresponds to the fourth software program. Then, the computing environment 102 can walk through the software program 104 and change the name where the previous name (of the second software program) is identified. In addition, the computing environment 102 can then process the change request through continuous integration techniques to verify that the change works. Upon determining that the change works, the change is implemented and used for the software program 104. If the computing environment 102 determines that the change request does not work or causes an error, then a notification about the change and error can be output to the client device 120 such that the change and the error can be manually investigated and implemented. If the computing environment 102 implements the change and then the change is determined not to work, the computing environment 102 can revert the dependencies 106 back from the fourth software program to the second software program for the software program 104.

In some examples, performing the action may involve the computing environment 102 causing a presentation of a notification indicating the update. That is, the notification can indicate that the third software program updated from depending on the second software program to depending on the third software program. The notification can also indicate that the software program 104 has the first dependency on the second software program. The notification may be presented at a client device 120, which may be associated with a software developer. So, based on the notification, the software developer can determine whether to update the first dependency from the second software program to the fourth software program for the software program 104. If the software developer determines that the software program 104 is to be updated to rely on the fourth software program, the software developer can cause the updates to generate the updated dependencies 110 for the software program 104.

In some examples, the monitoring engine 112 can identify a change in dependency tree of one software program, identify a similar dependency in a dependency tree of another software program, and cause a notification or an update for the other software program. For example, upon the updated dependencies 110 being generated, the dependency tree 105 can also be updated to indicate the change to the dependencies 106 and the lower-level dependencies 108. The monitoring engine 112 can receive or identify another dependency tree for another software program (e.g., a fifth software program) that indicates that the fifth software program has a dependency on the second software program and a dependency on the third software program. The second dependency tree also indicates that the third software program has a dependency on the second software program. Because the dependency for the third software program was updated from the second software program to the fourth software program in the dependency tree 105 for the software program 104, the monitoring engine 112 can also determine that the dependency of the third software program can be updated for the fifth software program, such that the third software program relies on the fourth software program rather than the second software program. The computing environment 102 can then cause another action associated with updating the dependency of the third software program on the third software program and the fifth software program on the third software program so that they reply on the second software program. As such, changes in dependencies for one software program can be propagated to other software programs based on their dependency trees.

The above process can provide a custom-tailored updating scheme that depends on how the software is actually used in a given computing environment. Since the same software application may be used in different ways in different computing environments, this process may result in a different sequence of updates being applied to the same software program in different computing environments. As a result, two different computing environments may update the same software program in different ways. For instance, a first computing environment may update a software program with a first set of updates and not a second set of updates, and a second computing environment may update the same software program with the second set of updates and not the first set of updates. So, if an update to a lower-level dependency is not relevant for a software program, the first-level dependency may not be updated. This is in contrast to conventional updating approaches, in which a one-size-fits-all update is rolled out to all end users at the same time.

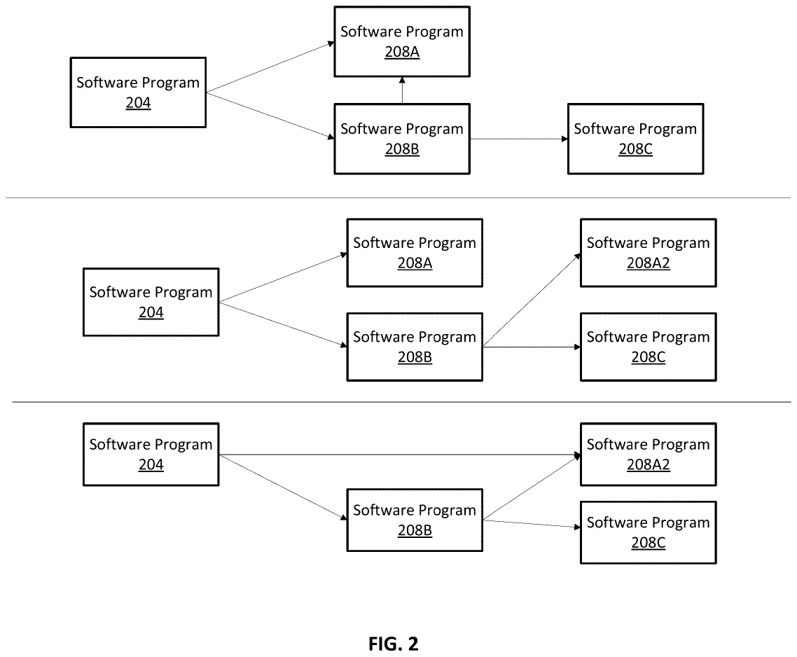

Turning now to FIG. 2, shown is an example of a lower-level dependency update being applied to a software program 204 according to some aspects of the present disclosure. As shown in the top section of FIG. 2, the software program 204 can initially have dependency on software program 208A and a dependency on software program 208B. In addition, software program 208B has a dependency on software program 208A and a dependency on software program 208C, which are each lower-level dependencies. Independently of the software program 204, software program 208B can replace its dependency on software program 208A with a dependency on software program 208A2, which can be considered a complex upgrade. The result of the update to the new version of software program 208B is shown in the middle section, where the software program 204 still depends on software program 208A, but software program 208B now depends on software program 208A2 and software program 208C. This change can be communicated to a client device associate with a developer of the software program 204, who can consider whether switching the dependency of the software program 204 on software program 208A to software program 208A2 is advisable. The update may be performed automatically or manually. Once the software program 204 is updated, the result is shown in the bottom section, where both the software program 204 and software program 208B depend on software program 208A2.

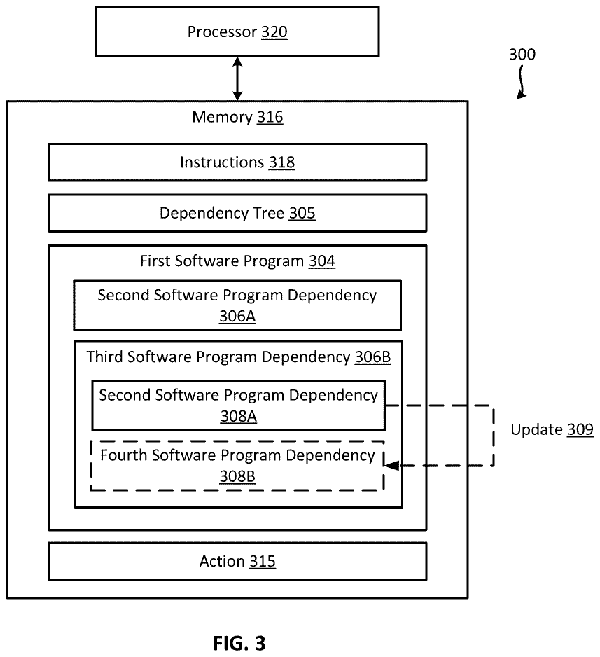

FIG. 3 shows a block diagram of an example of a computer system 300 for detecting updates to lower-level dependencies for a software program according to some aspects of the present disclosure. As shown, the computer system 300 can include a processor 320 communicatively coupled to a memory 316 by a bus. The processor 320 can include one processing device or multiple processing devices. Non-limiting examples of the processor 320 include a Field-Programmable Gate Array (FPGA), an application-specific integrated circuit (ASIC), a microprocessor, or any combination of these. The processor 320 can execute instructions 318 stored in the memory 316 to perform operations, such as any of the operations described herein with respect to the computing environment 102. In some examples, the instructions 318 can include processor-specific instructions generated by a compiler or an interpreter from code written in any suitable computer-programming language, such as C, C++, C#, Python, or Java.

The memory 316 can include one memory device or multiple memory devices. The memory 316 can be volatile or non-volatile, such that the memory 316 retains stored information when powered off. Non-limiting examples of the memory 316 include electrically erasable and programmable read-only memory (EEPROM), flash memory, or any other type of non-volatile memory. At least some of the memory device can include a non-transitory computer-readable medium from which the processor 320 can read the instructions 318. A computer-readable medium can include electronic, optical, magnetic, or other storage devices capable of providing the processor 320 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 318.

In some examples, the processor 320 can execute the instructions 318 to perform operations. For example, the processor 320 can receive a dependency tree 305 associated with a first software program 304. The dependency tree 305 can indicate that the first software program 304 has a first dependency on a second software program, illustrated as second software program dependency 306A, and a second dependency on a third software program, illustrated as third software program dependency 306B. The dependency tree 305 can further indicate that the third software program has a third dependency on the second software program, illustrated as second software program dependency 308A. The third dependency is a lower-level dependency of the first software program 304. The processor 320 can determine an update 309 to the third dependency for the third software program. The update 309 can be from relying on the second software program to relying on a fourth software program, as illustrated as fourth software program dependency 308B. The processor 320 can cause an action 315 associated with the first software program 304 based on determining the update 309. The action 315 may involve updating the second software program dependency 306A to a dependency on the fourth software program. Or, the action 315 may involve generating a notification about the update 309 for the third software program.

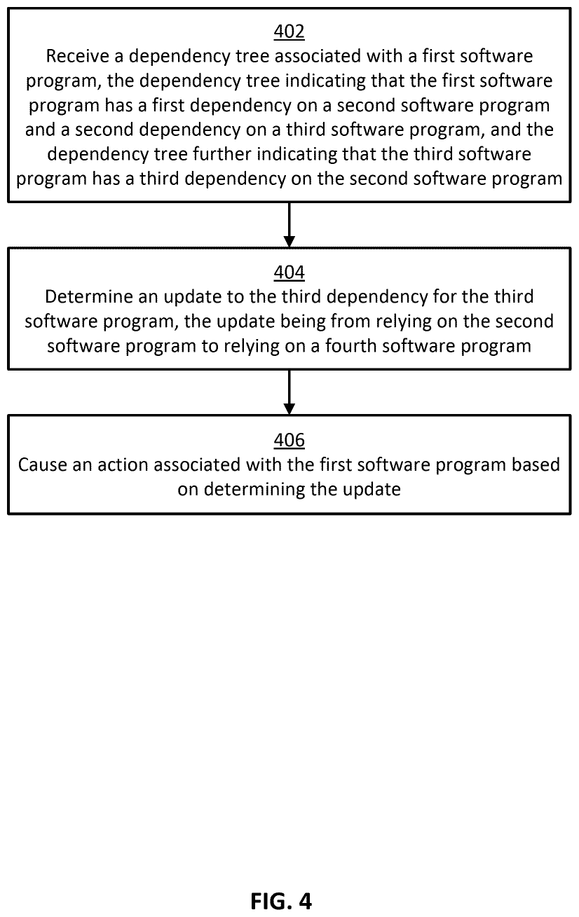

Turning now to FIG. 4, shown is a flowchart of an example of a process for detecting updates to lower-level dependencies for a software program according to some aspects of the present disclosure. Other examples may include more steps, fewer steps, different steps, or a different sequence of steps than is shown in FIG. 4. The steps of FIG. 4 are described below with reference to the components of FIG. 3 described above.

In block 402, the processor 320 receives a dependency tree 305 associated with a first software program 304. The dependency tree 305 can indicate that the first software program 305 has a first dependency on a second software program (e.g., second software program dependency 306A) and a second dependency on a third software program (e.g., third software program dependency 306B). The dependency tree 305 can further indicate that the third software program has a third dependency on the second software program (e.g., second software program dependency 308A). The processor 320 may receive the dependency tree 305 by accessing a repository that stores the dependency tree 305 along with the first software program 304. The dependency tree 305 can indicate first-level dependencies and lower-level dependencies of the first software program 304.

In block 404, the processor 320 determines an update 309 to the third dependency for the third software program. The update 309 can be from relying on the second software program to relying on a fourth software program (e.g., fourth software program dependency 308B). The fourth software program can be a new software program or a major version update for the second software program. The update 309 does not affect the second software program dependency 306A of the first software program 304. The processor 320 can determine the update 309 based on detecting a change to a dependency file associated with the third software program, where the change is from relying on the second software program to relying on the fourth software program.

In block 406, the processor 320 causes an action 315 associated with the first software program 304 based on determining the update 309. The action 315 may involve causing a notification about the update 309 and the first software program 304 including the second software program dependency 306A. Additionally or alternatively, the action 315 may involve the processor 320 causing the second software program dependency 306A for the first software program 304 to be updated to a dependency on the fourth software program. The processor 320 may also determine other software programs in the computing environment that have a dependency on the second software program and can update those other software programs to depend on the fourth software program rather than the second software program.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A system comprising:
one or more processors; and
one or more memories including instructions that are executable by the one or more processors for causing the one or more processors to perform operations including:
receiving a dependency tree associated with a first software program, the dependency tree indicating that the first software program has a first dependency on a second software program and a second dependency on a third software program, and the dependency tree further indicating that the third software program has a third dependency on the second software program;
determining an update to the third dependency for the third software program, the update being from relying on the second software program to relying on a fourth software program; and
causing an action associated with the first software program based on determining the update.

2. The system of claim 1, wherein the one or more memories include further instructions that are executable by the one or more processors for causing the one or more processors to perform operations including:
determining, based on the update, that the first dependency is to be updated such that the first software program relies on the fourth software program; and
causing the first dependency to be updated such that the first software program relies on the fourth software program by replacing the second software program with the fourth software program in the first dependency.

3. The system of claim 1, wherein the operation of causing the action comprises:
causing a presentation of a notification indicating the update and that the first software program has the first dependency on the second software program.

4. The system of claim 1, wherein the operation of determining the update comprises:
accessing a source code repository including the first software program, the second software program, and the third software program; and
determining a change to a first file associated with the third software program, the change indicating the update.

5. The system of claim 4, wherein the one or more memories include further instructions that are executable by the one or more processors for causing the one or more processors to perform operations including:
in response to determining the change to the first file, determining an indication of a type of the change in a second file associated with the third software program; and
determining that the first dependency of the first software program is to be updated based on the type of the change.

6. The system of claim 1, wherein the dependency tree is a first dependency tree, the action is a first action, and wherein the one or more memories include further instructions that are executable by the one or more processors for causing the one or more processors to perform operations including:
receiving a second dependency tree associated with a fifth software program, the second dependency tree indicating that the fifth software program has a fourth dependency on the second software program and a fifth dependency on the third software program, and the dependency tree further indicating that the third software program has a sixth dependency on the second software program; and
causing a second action associated with updating the fourth dependency based on the second dependency tree and determining the update to the third dependency for the third software program.

7. The system of claim 1, wherein the update is a first update, and wherein the one or more memories include further instructions that are executable by the one or more processors for causing the one or more processors to perform operations including:
determining the first update to the third dependency during a second update to the third software program.

8. A computer-implemented method comprising:
receiving a dependency tree associated with a first software program, the dependency tree indicating that the first software program has a first dependency on a second software program and a second dependency on a third software program, and the dependency tree further indicating that the third software program has a third dependency on the second software program;
determining an update to the third dependency for the third software program, the update being from relying on the second software program to relying on a fourth software program; and
causing an action associated with the first software program based on determining the update.

9. The method of claim 8, further comprising:
determining, based on the update, that the first dependency is to be updated such that the first software program relies on the fourth software program; and
causing the first dependency to be updated such that the first software program relies on the fourth software program by replacing the second software program with the fourth software program in the first dependency.

10. The method of claim 8, wherein causing the action comprises:
causing a presentation of a notification indicating the update and that the first software program has the first dependency on the second software program.

11. The method of claim 8, wherein determining the update comprises:
accessing a source code repository including the first software program, the second software program, and the third software program; and
determining a change to a first file associated with the third software program, the change indicating the update.

12. The method of claim 11, further comprising:
in response to determining the change to the first file, determining an indication of a type of the change in a second file associated with the third software program; and
determining that the first dependency of the first software program is to be updated based on the type of the change.

13. The method of claim 8, wherein the dependency tree is a first dependency tree, the action is a first action, and wherein the method further comprises:
receiving a second dependency tree associated with a fifth software program, the second dependency tree indicating that the fifth software program has a fourth dependency on the second software program and a fifth dependency on the third software program, and the dependency tree further indicating that the third software program has a sixth dependency on the second software program; and
causing a second action associated with updating the fourth dependency based on the second dependency tree and determining the update to the third dependency for the third software program.

14. The method of claim 8, wherein the update is a first update, and further comprising:
determining the first update to the third dependency during a second update to the third software program.

15. A non-transitory computer-readable medium comprising program code that is executable by one or more processors for causing the one or more processors to perform operations including:
receiving a dependency tree associated with a first software program, the dependency tree indicating that the first software program has a first dependency on a second software program and a second dependency on a third software program, and the dependency tree further indicating that the third software program has a third dependency on the second software program;
determining an update to the third dependency for the third software program, the update being from relying on the second software program to relying on a fourth software program; and
causing an action associated with the first software program based on determining the update.

16. The non-transitory computer-readable medium of claim 15, further comprising program code that is executable by the one or more processors for causing the one or more processors to perform operations including:
determining, based on the update, that the first dependency is to be updated such that the first software program relies on the fourth software program; and
causing the first dependency to be updated such that the first software program relies on the fourth software program by replacing the second software program with the fourth software program in the first dependency.

17. The non-transitory computer-readable medium of claim 15, wherein the operation of causing the action comprises:
causing a presentation of a notification indicating the update and that the first software program has the first dependency on the second software program.

18. The non-transitory computer-readable medium of claim 15, wherein the operation of determining the update comprises:
accessing a source code repository including the first software program, the second software program, and the third software program; and
determining a change to a first file associated with the third software program, the change indicating the update.

19. The non-transitory computer-readable medium of claim 18, further comprising program code that is executable by the one or more processors for causing the one or more processors to perform operations including:
in response to determining the change to the first file, determining an indication of a type of the change in a second file associated with the third software program; and
determining that the first dependency of the first software program is to be updated based on the type of the change.

20. The non-transitory computer-readable medium of claim 15, wherein the dependency tree is a first dependency tree, the action is a first action, and further comprising program code that is executable by the one or more processors for causing the one or more processors to perform operations including:
receiving a second dependency tree associated with a fifth software program, the second dependency tree indicating that the fifth software program has a fourth dependency on the second software program and a fifth dependency on the third software program, and the dependency tree further indicating that the third software program has a sixth dependency on the second software program; and
causing a second action associated with updating the fourth dependency based on the second dependency tree and determining the update to the third dependency for the third software program.
